(19) United States
(12) Patent Application Publication
(10) Pub. No.: US 2002/0054093 A1
(43) Pub. Date: May 9, 2002

(54) Ergonomic graphic interface for webpages, internet browsers and computers

(76) Inventor: Emmanuel C. Gonzalez, Metro Manila (PH)

Correspondence Address: FLEHR HOHBACH TEST ALBRITTON & HERBERT LLP, Suite 3400, Four Embarcadero Center, San Francisco, CA, 94111-4187, US

(21) Appl. No.: 09/968,258

(22) Filed: Oct. 1, 2001

Related U.S. Application Data
(60) Provisional application No. 60/238,303, filed on Oct. 4, 2000.

(51) Int. Cl. G09G 5/00

(52) U.S. Cl. 345/748

(57) ABSTRACT

A new graphic design for computer applications has as its function the provision of a more convenient and intuitive interface for internet webpages. This will make commands more intuitive and easier to use, and reduce hand motions and mouse clicks for a user. The same graphic design can also be adapted to internet browsers and other computer applications which are run locally.

### RELATED APPLICATIONS

This application claims priority to Provisional Application Serial No. 60/283,303 filed Oct. 4, 2000.

### FIELD OF THE INVENTION

This invention relates to the graphic design and layout of ergonomic graphic user interfaces for internet webpages, internet browsers and computers.

### BACKGROUND AND EXISTING PRACTICES

The vast majority of all physical computer setups involve a monitor or display above, a keyboard or other physical control panel below and a mouse or other pointing/drawing device below and generally on the right or in the center. Even among the ten percent of people who are left-handed, the scarcity of left-handed pointing devices has accustomed them to using mice positioned on the right. (As herein used, “computer” is taken to include all devices which comprise a digital processor, a set of controls and a visual display of any kind. As used herein, “mouse” is inclusive of touch-pads, trackballs, joysticks and similar devices.)

This fundamental design is echoed in television sets, cellular phones, palm-held digital devices, manual typewriters and even cars (the “display” being what is visible through the windshield). The design is not due to random chance, but follows from human anatomy—the fact that human use their hands (lower) to control things, and their eyes (upper) to absorb information. It is therefore a design which can be considered “natural” and “instinctive” for the vast majority of people.

So ingrained is the expectation on having control devices below a display that virtually all mouse users, when they move the cursor aside so as not to obstruct the information display, will choose the bottom right of the screen as its “resting place,” because it is both “below” and to the right.

Since there is no physical keyboard or other physical device which can adequately and fully interface with all the possible kinds of webpages or other software, it has become standard practice to represent controls and commands somewhere on the computer monitor screen. These screen representations must in turn be selected or activated by using a mouse or other pointing device. The mouse has therefore become an indispensable part of computer life, and there is virtually no software of any kind which does not require continuous mouse use to activate a variety of commands and controls represented on the monitor screen.

For simplicity hereafter, “screen control” shall refer in general to commands, buttons, entry boxes other representations for user input/manipulation which are represented on the screen of a computer monitor, as opposed to a “physical control device” such as a keyboard, mouse and the like. “Information display” is that portion of the monitor screen which is, at any given time, primarily devoted to the display of text or visual information, even if it contains elements which could be considered commands, such as hyperlinks.

However, most internet webpages, all internet browsers and most computer software applications, ignore and indeed defy the natural, intuitive “displayabove/controls-below” arrangement, by situating the main screen controls on top (and in some cases to the left) of the information display, and/or by having screen controls which can scroll off the visible display or change positions from one page to the next.

This means that a user must constantly “saw” the mouse cursor up and down between the lower-right resting place and the top-located screen controls, or hunt up and down with the scroll-bar to look for those controls. Many popular websites, such as search engines, portals and online vendors, position their most frequently used screen control, the search box, in the top center or top left, where it is furthest from the instinctive lower right resting position for the cursor, and quite far from the ubiquitous up-down scroll bar on the right. Moreover, these screen controls almost always scroll out of view, forcing the user to scroll back up to use them.

On subsequent pages, such as search results or product presentations, the search box and other important screen controls may reincarnate almost anywhere on the page, and are often difficult to find. It can be easily observed that most users of webpages, in particular search engines, portals and online vendors, have to expend considerable effort positioning and repositioning their mouse cursors to access different controls.

In the two leading internet browsers, Microsoft Explorer and Netscape Navigator, top-positioned controls lead to similar results, with the most-used commands, the open URL line and the “back” button, all positioned at the top, forcing a user to saw up and down continuously.

Poor, non-intuitive design slows down the retrieval of information and is physically and mentally tiring. This is disadvantageous both for users and website/software publishers. It constitutes a form of needless discrimination against persons with disabilities related to their eyesight or hands. Over an extended period of time, with extensive use, it could even lead to physical injury to some users.

### SUMMARY OF THE INVENTION

The invention is a graphic user interface for internet webpages, internet browsers and computer software, which provides for 1) a constant display of some or all of the software command buttons and other user input graphics such as search boxes, selection dials, tables and other controls, especially the most frequently used of such graphics, in such a manner that they cannot be scrolled off the screen display, nor do they need to be re-drawn with each new page that is accessed, and 2) the positioning of command buttons and user input devices as an array or arrays on the right and/or bottom of the display screen.

### BRIEF DESCRIPTION OF THE DRAWINGS

The invention will be more clearly understood by reading the following description in connection with the accompanying drawings in which:

FIG. 1 is a representation of a user interface in accordance with one embodiment of the invention.

FIG. 2 is a representation of a user interface showing a different configuration.

FIG. 3 is a representation of the user interface of FIG. 2 with displayed graphics.

### DETAILED DESCRIPTION

Internet-based applications are those which are run in whole or in part from remote computers and “served” via internet to a user's computer or analogous device. This category includes all websites of any nature, and a growing number of software programs and multi-player games which are accessed through the internet, with most of the calculations involved in running the program being performed by a remote “server” computer, then communicated as a display and interface on the user's computer.

Local applications are those which are substantially run from software loaded in a hard drive or in a storage device (such as a floppy disk or CD-ROM) which is directly attached to a central processing unit in a user's own computer or local computer network. This category includes most conventional packaged or bundled software, such as word processors, spreadsheet and accounting programs, games and internet browsers (which, though they serve to open internet websites are themselves locally run). Local software applications can be constructed in any of several computer languages, commonly one which is capable of projecting a graphic display onto a computer screen and allowing a user to interface with the CPU through the graphic display. An example of such a language is Visual Basic.

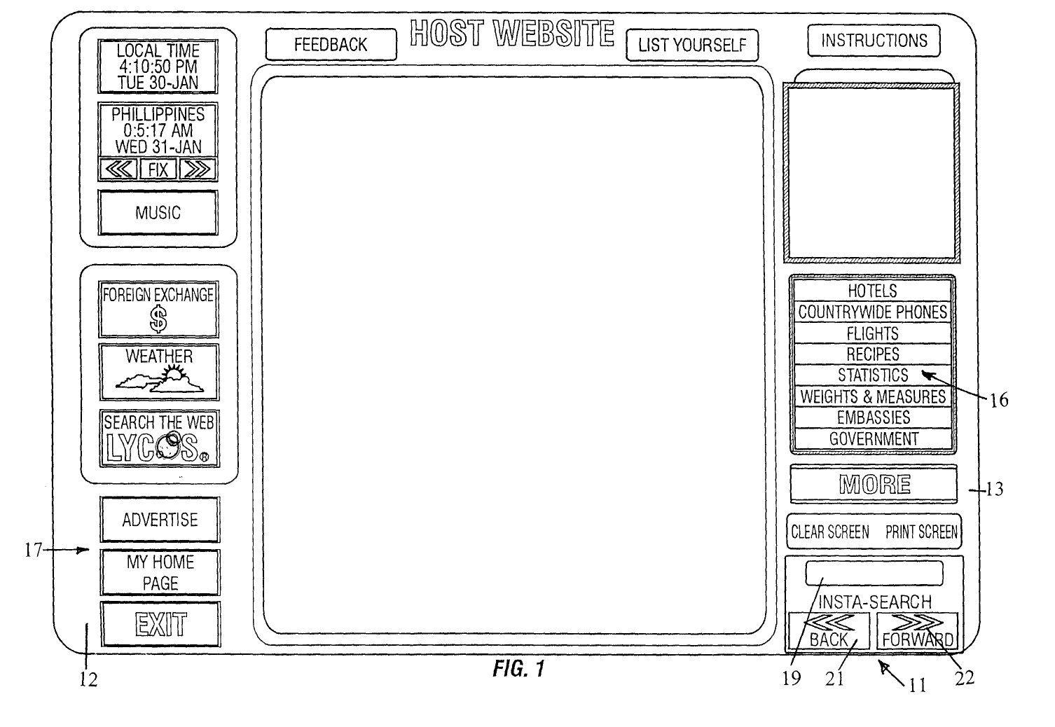

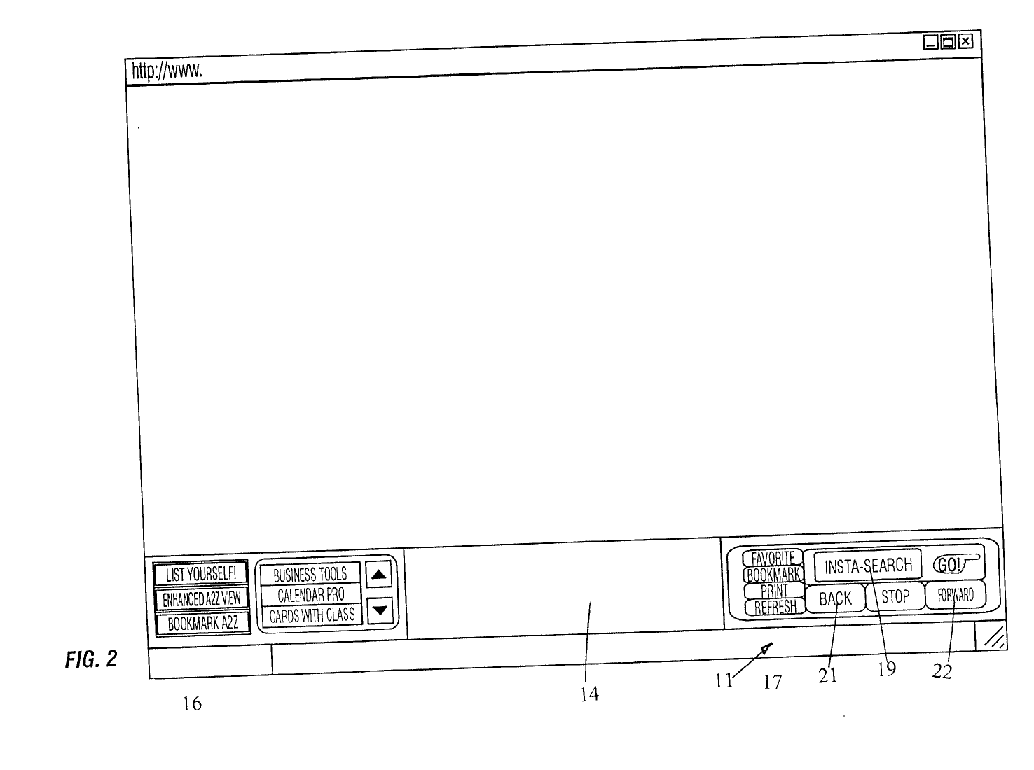

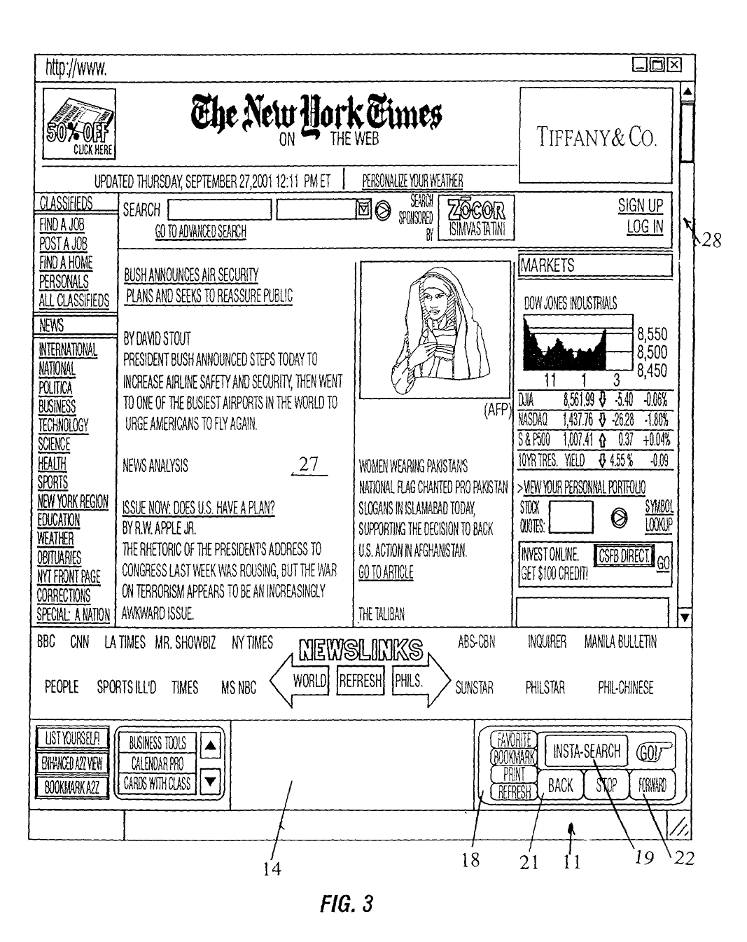

Regardless of whether an application is local or internet-based, an appropriate computer language can be used to create the inventive ergonomic user interface such as shown in FIGS. 1, 2 and 3. The user interface can include the following elements: 1) The principal screen controls 11 (graphic elements which may include text, images or buttons imaged by the software whose function is to provide inputs or commands, that can reasonably be expected to be the most-frequently used) are permanently positioned on screen, and cannot scroll out of view, nor do they need to be re-drawn with each new page or display. For websites, this can be achieved with the use of HTML frames, which allow the monitor screen to be partitioned into independent segments 12 or 13, FIGS. 1 and 14, FIGS. 2 and 3, each separately addressable. In a typical website, the most frequently used controls 11 will include the buttons 16, 17, FIG. 1, which open the major pages, and 19, FIGS. 2 and 3, and the search box 19 (if there is one). By making the controls permanent, cycling time between pages is reduced, since there is less information that has to be recreated by the computer. The principal screen controls are preferably programmed to appear in an array on the right or bottom of the monitor screen, instead of the top or left, where they are conventionally placed.

For applications which have a very large number of controls which could be considered “frequently used,” provision can be made for a user to specify which controls he/she prefers to position in a fixed, always visible, location. In the case of a search engine or any other kind of website where the search function is an important element, the search box 19 is permanently positioned in the lower right corner. In the case of an internet browser, the open URL interface and “back/forward” buttons 21, 22 are permanently positioned in the lower right corner.

In the case of a primary or first control which requires a series of further choices before a command can be fully defined, a means for recalling and automatically re-representing the last used such sequence of choices, without the need for making multiple choices each time. For example, a typical website offering weather reports requires the user to click on several successive geographic choices before the user can finally select a particular desired city; a website which recalls the last-accessed city automatically (while allowing the user to make a new choice) would save many users considerable effort (i.e. those users only concerned with the weather for their particular place of resident).

To further reinforce the sense that the graphic interface represents or corresponds to a physical reality (thus making it more intuitive to use), the controls described above could be designed to look like a physical console panel. By representing a physical object, the controls would be easier for many people to understand and employ.

Referring particularly to FIGS. 2 and 3, the search box 19, back/forward buttons 21, 22, favorite, bookmark, print and such bottons are located in the lower right corner. The toolbar at the bottom of the display displays various newspaper websites which can be selected. By selecting “The New York Times” the web pages are displayed in the display section 27, FIG. 3. The newspaper can be scrolled by the scroll bar 28. However, the screen controls remain fixed.

The ergonomic graphic display has the following advantages:

1. Toolbars and repeating graphics do not have to be re-drawn by the computer each time a new page is accessed. This speeds up the loading of new pages.

2. Simulated console displays allow a more logical placement of commands and buttons with different functions for expected frequencies of use, making site navigation more intuitive and less reader intensive than the single-toolbar approach used by a few sites. This kind of display is thus described as “ergonomic.”

3. The permanent location of the simulated screens within the display provides a visual cue which reduces the visual and mental strain needed to understand a display or to find information on the displays. For example, a main screen could display the content asked for in a search, while a smaller guide screen in the margins could offer advice to the user on what to do next. Knowing that the smaller screen usually displays “advice,” a user (after a little practice) will instinctively turn his or her eye to that screen when help is needed.

4. By representing a physical object, the display seems more inviting and provides an ersatz “tactile” dimension which will be appreciated by most if not all users. Many users with a right-brain orientation will find the simulated-console display easier to use than conventional website interfaces, thus facilitating internet participation by a large segment of the public.

5. Providing a constant main frame eliminates the risk that a user will get lost within a site or have difficulty navigating it. The current art of providing site maps is perhaps useful to the mechanically inclined, but does little to guide the average non-mechanical lay person.

6. Finally, the use of screens-within-the-real-screen permits the orderly presentation of online advertising when a given screen is idle, without cluttering the overall look of a page and without confusing the user as to which items are part of the website and which are transient advertising.

In summary, the ergonomic graphic interface offers many advantages over other webpage designs. While this kind of interface will not be appropriate for all publishers, it is particularly well-suited to websites which need to display a large variety of different kinds of information in an orderly and appealing manner. Examples of such websites are: portals, list sites, newspapers and magazines, online catalogues, and online vendors.

The foregoing descriptions of specific embodiments of the present invention are presented for the purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. An interactive graphic display for websites, internet browsers and computers comprising:
a display screen which includes an information display section and a control section located at least in part at the lower right hand portion of the screen.

2. An interactive display as in claim 1 in which the control section includes additional controls along the bottom of the screen.

3. An interactive display as in claim 1 in which the information display section is within a screen frame which includes additional controls and information displays.

4. An interactive display as in claim 1 in which the control section includes a search box.

5. An interactive display as in claim 1 in which the control section cannot be scrolled out of sight.

6. An interactive display as in claim 1 in which the controls at the bottom right hand portion of the screen includes back and forward buttons and a search box.

7. An interactive display as in claim 3 in which the central section includes an information display section.

8. An interactive display for websites, internet browsers and computers comprising:
a display and user interface with control buttons, user-input and/or user-command elements arranged so as to appear in whole or in part on the right or bottom sections of the monitor screen.
